(19) United States
(12) Patent Application Publication
(10) Pub. No.: US 2001/0050653 A1
(43) Pub. Date: Dec. 13, 2001

(54) Apparatus and method for reducing polarization cross-coupling in cross dipole reflectarrays

(76) Inventors: Kevin C. Clancy, Thousand Oaks, CA (US); Michael E. Cooley, Leesburg, VA (US); David Bressler, Los Angeles, CA (US)

Correspondence Address: Patent Records Administration, Hughes Electronics Corporation, Bldg 001/A109, P O Box 956, El Segundo, CA, 90245-0956, US

(21) Appl. No.: 09/525,100

(22) Filed: Mar. 14, 2000

(51) Int. Cl. H01Q 9/28; H01Q 15/02; H01Q 15/24

(52) U.S. Cl. 343/795; 343/700 MS; 343/909

(57) ABSTRACT

A method and apparatus for improving polarization purity of a reflectarray that eliminates cross-coupling between orthogonal polarizations. A first embodiment of the present invention is a grid layer that separates two layers of orthogonal dipole elements. A second embodiment of the present invention is a reflectarray having an array of dipole elements in which each dipole element is gridded to prevent cross-coupling between orthogonal polarizations.

### TECHNICAL FIELD

The present invention relates to signal transmission systems using reflectarray antennas in which phasing elements are constructed to improve polarization purity by reducing coupled mode dipole currents. More particularly the phasing elements are constructed to prevent the orthogonal elements from affecting the desired polarization pattern.

### BACKGROUND ART

It is known to use microwave-phasing structures, commonly known as reflectarrays, for electromagnetically emulating shaped reflective surfaces. Typically, the emulation is of a parabolic shape that focuses waves to or from a pencil shaped beam. The emulation occurs by controlling the reflection phases of elements that populate the reflectarray surface. Imposing variations in the size, shape, length, etc. of the elements controls the element reflection phases. These elemental variations effectively modify the elemental reactance thereby inducing a reflection phase shift.

A preferred method of forming the phasing elements is to construct coplanar crossed dipole elements on a flat surface. By varying the length and the width of the conductor elements used in forming a dipole, the phase of the reflected energy is varied. Thus, by controlling the reflection phases of the surface dipoles, an antenna beam can be synthesized thereby emulating the mechanical shaping of a conventional parabolic reflector. Such elements permit the antenna structure to be made substantially flat and still emulate the performance of larger and bulkier parabolic dishes. These reflectarray elements provide only modest polarization purity because electrical currents can couple directly from one dipole arm to the orthogonal dipole arm. This cross polar current coupling mechanism has been analyzed as set forth in E. L. Pelton and B. A. Munk, “Scattering from Periodic Arrays of Crossed Dipoles”, IEEE Trans. Antennas Propagate, Vol. AP-27, no. 3, pp. 323-330, May, 1979.

An asymmetric dipole current phase distribution will occur whenever the incidence angle is not constrained to a predetermined plane. This asymmetry causes direct coupling of currents to the orthogonal dipole arms. Since reflectarray surfaces, like conventional reflectors, are illuminated by way of antenna feeds with associated oblique incidence angles, reflectarray cross polarization levels are adversely affected by the asymmetric current coupling effect.

U.S. Pat. No. 5,543,809 attempts to purify the polarization by providing a reflectarray antenna in which the phasing elements are modified to physically separate the dipole conductor arms. The element arms, or conductors, are separated over the surface area of a substrate, or substrates. The relatively small spacing, or separation, between the dipole arms will prevent direct current coupling and substantially reduce the levels of cross-polarized fields.

Another known antenna includes separation in a direction normal to the plane of the substrate and is preferably provided by forming conductor arms on opposite surfaces of a substrate. Alternatively, the conductor arms are separated within the plane of the substrate to provide similar reductions in cross-polarized fields.

The dipole elements in these known structures are solid metal conductors. This causes some distortion from coupling between orthogonal polarizations. So while cross-coupling of polarizations is reduced by spatial separation of the orthogonal dipole arrays, spatial separation alone does not eliminate the problem because the orthogonal dipoles are still at approximately the same spacing from a solid ground plane.

### SUMMARY OF THE INVENTION

The present invention is an apparatus and method for reducing the polarization distortion due to coupling that occurs between orthogonal polarizations.

In one embodiment of the present invention, a grid separates two planar dipole arrays, which is a set of parallel wires or a set of thin metal strips. The grid is oriented such that it is parallel to a first set of dipoles and forms an associated ground plane. The second set of dipoles has its own ground plane and both the dipoles and the associated ground plane are located behind the first set of dipoles. Both sets of dipoles share a common aperture. The grid separates the dipoles a distance that is outside of the resonant frequency to avoid coupling between opposing polarizations.

Another embodiment of the present invention has two coplanar dipole arrays with gridded dipoles. The gridded dipoles are independent, orthogonal dipoles, each formed from several parallel wires or metallic strips. The gridded dipoles are on the same plane and share a common ground plane and aperture. The individual dipoles are gridded and the separation does not allow coupling between orthogonal waves.

The present invention is advantageous in that it allows an increase in frequency bandwidth over which the cross-dipole reflectarray designs will produce a desired beam shape. Prior art designs require very narrow dipole widths, on the order of 0.03λ, to mitigate interaction between orthogonal dipoles. The separation of the dipoles according to the present invention, i.e. separation by way of a grid between dipole arrays on separate planes, or gridded dipoles on the same plane, virtually eliminates interaction between orthogonal dipoles. The present invention reduces distortion on one polarization caused by the orthogonal array of dipoles.

It is an object of the present invention to reduce polarization cross-coupling in cross dipole reflectarrays. It is another object of the present invention to separate orthogonal dipoles by a grid arrangement.

It is a further object of the present invention to provide a grid arrangement in which two arrays of dipoles on separate planes are separated by a grid layer. It is still a further object of the present invention to provide two dipole arrays on the same plane with gridded dipole elements.

Other objects and features of the present invention will become apparent when viewed in light of the detailed description of the preferred embodiment when taken in conjunction with the attached drawings and appended claims.

### BRIEF DESCRIPTION OF THE DRAWINGS

In order that the invention may be well understood, there will now be described some embodiments thereof, given by way of example, reference being made to the accompanying drawings, in which:

FIG. 1 is a diagrammatic view of a communication system having a gridded reflectarray according to one embodiment of the present invention;

FIG. 2 is an exploded view of the reflectarray shown in FIG. 1;

FIG. 3 is a diagrammatic view of a gridded reflectarray according to another embodiment of the present invention; and

FIG. 4 is an exploded view of the reflectarray shown in FIG. 3.

### BEST MOLE(S) FOR CARRYING OUT THE INVENTION

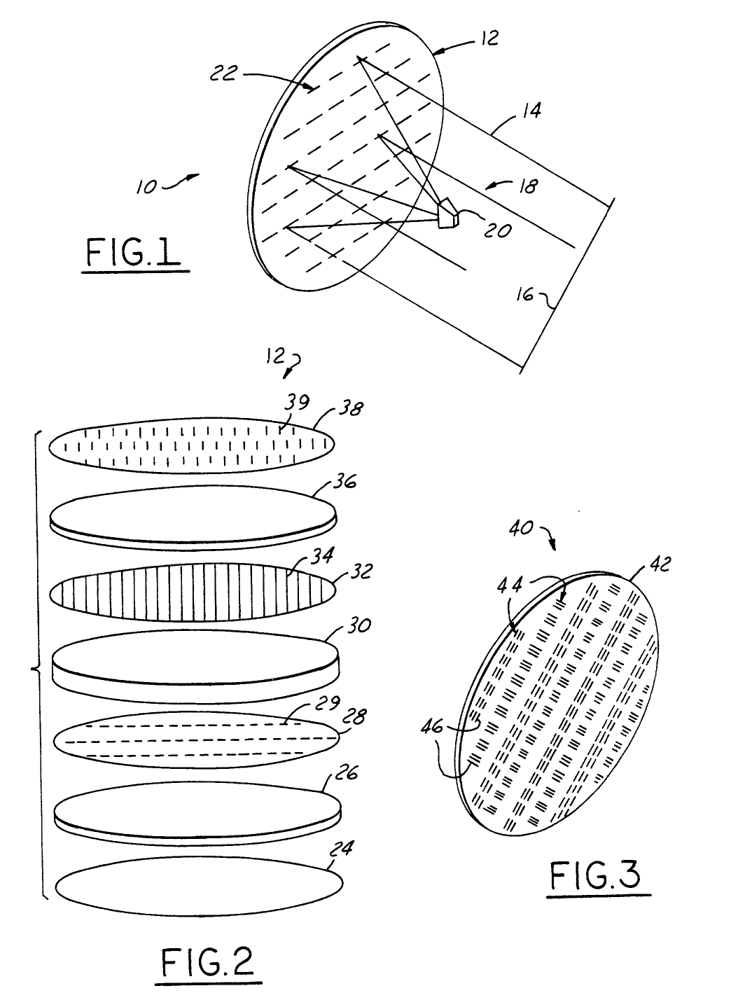

FIG. 1 is a diagrammatic view of a communications system 10 having a reflectarray antenna 12, typically used in a communications satellite. The reflectarray antenna 12 transmits and/or receives an electromagnetic wave signal 14 from a source 16. Typically, the source 16 transmits linear, dual linear, or circularly polarized signals. The antenna 12 collimates energy to or from a feed 18, such as a waveguide horn 20 as shown in FIG. 1. The reflectarray antenna 12 includes a plurality of phasing elements 22 that re-radiate incident radio frequency (RF) radiation with phase shifts to emulate geometric shaping, parabolic for example, of a conventional reflector.

Referring now to FIG. 2, a first embodiment of the reflectarray antenna 12 of the present invention is shown in an exploded view. The reflectarray antenna 12 has a ground plane 24 over which is placed a thin layer 26 of dielectric material, such as Rohacell 51 HF. A phase element layer 28 having an array of dipoles wherein each dipole 29 has a predetermined polarization, i.e. horizontal as shown in FIG. 2, is located above the first dielectric layer 26. The dipoles 29 are preferably etched into a sheet of copper-clad Kapton.

In the present example, the width of the dipoles is 0.06λ, and the length is varied between 0.01λ, and 0.06λ. The length is determined by any means known in the art in order to achieve the desired beam shape. It should be noted that these dimensions are given by way of example only and may be altered by one of ordinary skill in the art without affecting the outcome of the present invention. The reflectarray antenna 12 is now completed for a single polarization.

In the embodiment shown in FIG. 2, the second polarization is added on a separate plane. A dielectric layer 30 is located above the first dipole array 28. A grid layer 32 is located on top of the second dielectric layer 30. The grid layer 32 is made of grid lines 34 that can be a set of parallel wires or thin metal strips. The grid lines 34 are arranged to be perpendicular to the first dipole array 28. In the present example, the grid lines are 0.01λ in width and are spaced 0.15λ apart. As discussed above, the dimensions are for example purposes only. A third dielectric layer 36 is placed above the grid layer 32.

The second polarization is completed by a dipole array 38 located above the third dielectric layer. The dipole array 38 has phase elements 39 arranged to be parallel to the grid lines 34 on the grid layer 32 and orthogonal to the phase elements 29 of the first dipole array 28. The second dipole array 38 is also preferably etched into a Kapton film as well.

The grid layer 32 in the first embodiment forms an independent ground plane for the second dipole array 38. Therefore, in the first embodiment, each dipole array 28, 38 has its associated ground plane 24 and 32 respectively. The first ground plane 24 being solid and the grid layer 32, or second ground plane, being gridded. The dipoles are separated from the orthogonal grid such that the distance between the dipole layers and the grid is outside of the resonant frequency. The grid prevents a resonance and avoids coupling between opposing polarizations.

Another embodiment of the present invention is shown in FIG. 3. The dipole arrays 42 are coplanar. However, the dipole elements 44 themselves are gridded. Each dipole element 44 is formed from a plurality of grid lines 46. The grid lines 46 can be parallel wires or metallic strips.

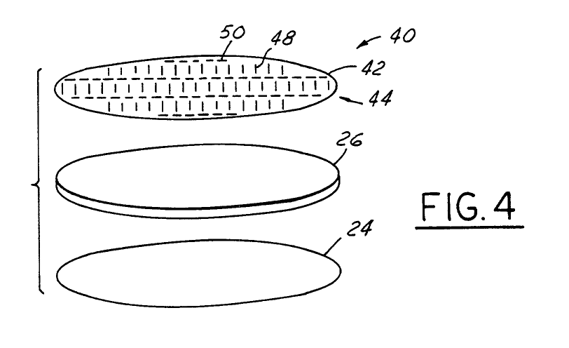

Referring to FIG. 4, an exploded view of the reflectarray antenna is shown. The reflectarray antenna 40 has a ground plane 24 and a dielectric layer 26. The gridded dipole elements 44 have a vertical element 48 and a horizontal element 50. While both the vertical and horizontal elements 48 and 50 are formed on the same layer 42, they are spaced apart from each other a predetermined distance. The distance is chosen such that electromagnetic coupling between the dipole elements 48, 50 is minimized.

In the embodiment shown in FIG. 4, a single, solid metallic ground plane 24 is shared between both polarizations. The gridded dipole elements 44 virtually eliminate the distortion on one polarization caused by the orthogonal dipoles. Because the dipoles themselves are gridded, or in other words have separations therein, there is no coupling whatsoever. The dipoles themselves do not allow cross-coupling with orthogonal polarizations.

While particular embodiments of the invention have been shown and described, numerous variations and alternate embodiments will occur to those skilled in the art. Accordingly, it is intended that the invention be limited only in terms of the appended claims.

What is claimed is:

1. A reflectarray comprising:
a ground plane;
a first layer suspended over said ground plane and having an array of dipole elements in a first predetermined direction;
a second layer suspended over said ground plane and having an array of dipole elements in a direction orthogonal to said first predetermined direction; and
a grid layer disposed between said first and second layers wherein said grid layer has a predetermined thickness and a plurality of conductive lines in said first predetermined direction.

2. The reflectarray as claimed in claim 1 wherein said conductive lines are a set of parallel wires.

3. The reflectarray as claimed in claim 1 wherein said conductive lines are a set of metal strips.

4. A reflectarray comprising:
a ground plane; and
a substrate suspended over said ground plane having an array of dipole elements, said array having adjacent rows wherein each row has dipole elements in a first predetermined direction and an adjacent row has dipoles in an orthogonal direction, said dipole elements each being a plurality of conductive lines.

5. The reflectarray as claimed in claim 4 wherein said plurality of conductive lines are parallel wires.

6. The reflectarray as claimed in claim 4 wherein said plurality of conductive lines are metallic strips.

7. A method for improving polarization purity in a reflectarray comprising the steps of:
inserting a grid layer between a first layer having an array of dipole elements and a second layer having an array of orthogonal dipole elements, wherein said grid layer has a predetermined thickness and has a plurality of grid lines in the direction of said dipole elements of said first layer.

8. A method for improving polarization purity in a reflectarray comprising the steps of:
forming an array of dipole elements on a substrate, each row having dipole elements in an alternating orthogonal direction to dipole elements in an adjacent row, and wherein each dipole element is comprised of a plurality of parallel conductive lines.
